(19) United States
(12) Patent Application Publication
(10) Pub. No.: US 2009/0120711 A1
(43) Pub. Date: May 14, 2009

(54) WORM GEAR AND ELECTRIC POWER STEERING APPARATUS

(75) Inventor: Kohtaro Shiino, Isehara-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/267,862

(22) Filed: Nov. 10, 2008

(30) Foreign Application Priority Data
Nov. 12, 2007 (JP) 2007-292779

(51) Int. Cl. F16H 1/16; B62D 5/04

(52) U.S. Cl. 180/443; 74/425

(57) ABSTRACT

A worm gear includes a worm shaft including a thread including a tooth flank that defines a concave edge in a tooth profile of the thread; and a worm wheel including a tooth including a tooth flank that defines a convex edge in a tooth profile of the tooth. The worm wheel meshes with the worm shaft in such a manner that the tooth flank of the worm wheel and the tooth flank of the worm shaft, as working flanks, define therebetween an entrance-side clearance as a clearance where the thread of the worm shaft starts to mesh with the tooth of the worm wheel, and an exit-side clearance as a clearance where the meshing terminates, wherein the exit-side clearance is smaller than the entrance-side clearance.

### BACKGROUND OF THE INVENTION

The present invention relates to worm gears and electric power steering apparatuses provided with worm gears.

Japanese Utility Model Application Publication No. 4-56250 discloses a worm gear including so called a Niemann worm having a Niemann tooth profile. The Niemann worm includes a thread including a tooth flank that defines an arc-concave edge in a tooth profile of the thread and is positively shifted. The Niemann tooth profile is expected to provide smaller pressure angles, and a larger relative radius of curvature between working flanks, for providing a higher load capacity.

### SUMMARY OF THE INVENTION

For the Niemann tooth profile, the difference between the thickness of a tooth at the tip and the thickness of the tooth at the root or at the pitch circle tends to be large, because of the arc-concave tooth flanks. This may cause, depending on specifications of a worm gear, a condition that both of entrance-side and exit-side clearances between a working flank of a worm and a working flank of a worm wheel are large so that the thread of the worm contacts only a central portion, in the direction of tooth trace, of the worm wheel, and thereby cause an increase in bending stress of the tooth of the worm wheel.

If the worm wheel includes a part made of resin which meshes with the worm, the bending stress of the worm wheel is further expected to be reduced.

In view of the foregoing, it is desirable to provide a worm gear and an electric power steering apparatus in which the bending stress of a worm wheel is reduced.

According to one aspect of the present invention, a worm gear comprises: a worm shaft including a thread including a tooth flank that defines a concave edge in a tooth profile of the thread; and a worm wheel including a tooth including a tooth flank that defines a convex edge in a tooth profile of the tooth, the worm wheel meshing with the worm shaft in such a manner that the tooth flank of the worm wheel and the tooth flank of the worm shaft, as working flanks, define therebetween an entrance-side clearance as a clearance where the thread of the worm shaft starts to mesh with the tooth of the worm wheel, and an exit-side clearance as a clearance where the meshing terminates, wherein the exit-side clearance is smaller than the entrance-side clearance. The worm wheel may mesh with the worm shaft in such a manner that the tooth of the worm wheel is inclined with respect to the thread of the worm shaft in a direction to increase a lead angle of the worm shaft. The worm wheel may have a larger lead angle than the worm shaft by an angle of 0.2 to 0.7 degree. The worm gear may be configured so that along a tooth trace of the worm wheel, the tooth flank of the worm wheel includes opposite halves having different shapes so that the exit-side clearance is smaller than the entrance-side clearance. The worm wheel may be formed by molding. The tooth flank of the worm wheel as a working flank and an opposite tooth flank of the worm wheel as a non-working flank may have different shapes so that the exit-side clearance is smaller than the entrance-side clearance. The worm wheel may include a part made of resin which forms at least the tooth flank of the worm wheel.

According to another aspect of the present invention, a worm gear comprises: a worm shaft including a thread including a tooth flank that defines a concave edge in a tooth profile of the thread; and a worm wheel including a tooth including a tooth flank that defines a convex edge in a tooth profile of the tooth, the worm wheel meshing with the worm shaft in such a manner that the tooth flank of the worm wheel and the tooth flank of the worm shaft, as working flanks, are subject to a first contact pressure therebetween on an entrance side where the thread of the worm shaft starts to mesh with the tooth of the worm wheel, and a second contact pressure therebetween on an exit side where the meshing terminates, wherein the second contact pressure is higher than the first contact pressure.

According to a further aspect of the present invention, a worm gear comprises: a worm shaft including a thread including a tooth flank that defines a concave edge in a tooth profile of the thread; and a worm wheel including a tooth including a tooth flank that defines a convex edge in a tooth profile of the tooth, the worm wheel meshing with the worm shaft in such a manner that the tooth of the worm wheel is inclined with respect to the thread of the worm shaft in a direction to increase a lead angle of the worm shaft. The worm gear may be configured so that the worm shaft and the worm wheel form a shaft angle of 90 degrees, and the worm wheel has a larger lead angle than the worm shaft. The worm gear may be configures so that the worm wheel and the worm shaft have identical lead angles, and the worm shaft and the worm wheel form such a shaft angle that the tooth of the worm wheel is inclined with respect to the thread of the worm shaft in the direction to increase the lead angle of the worm shaft.

According to a still further aspect of the present invention, an electric power steering apparatus comprises: a steering shaft connected between a steering wheel and a steered wheel set; an electric motor for applying a torque to the steering shaft; a worm shaft coupled to an output shaft of the electric motor, the worm shaft including a thread including a tooth flank that defines a concave edge in a tooth profile of the thread; and a worm wheel coupled to the steering shaft, the worm wheel including a tooth including a tooth flank that defines a convex edge in a tooth profile of the tooth, the worm wheel meshing with the worm shaft in such a manner that the tooth of the worm wheel is inclined with respect to the thread of the worm shaft in a direction to increase a lead angle of the worm shaft.

### BRIEF DESCRIPTION OF THE DRAWINGS

FIG. 1 is a schematic diagram showing construction of an electric power steering apparatus of an automotive vehicle according to first and second embodiments of the present invention.

FIG. 2 is a side sectional view of a speed reducer of the electric power steering apparatus of FIG. 1.

FIG. 3 is a sectional view of the speed reducer taken along the line III-III shown in FIG. 2.

FIG. 4 is a side view of a worm shaft adapted to constitute the speed reducer of FIG. 3.

FIG. 5 is an enlarged partial sectional view of the worm shaft taken along the line V-V shown in FIG. 4.

FIG. 6 is a partial sectional view of a tooth of a worm shaft according to a reference example.

FIG. 7 is a diagram showing the worm shaft and a worm wheel which are in meshing contact with each other, and adapted to constitute the speed reducer of FIG. 3.

FIG. 8 is an enlarged diagram showing a condition that a tooth of the worm shaft and a tooth space of the worm wheel are in meshing contact with each other in the speed reducer of FIG. 3.

FIG. 9 is a diagram showing a condition that a tooth of a worm shaft and a tooth space of a worm wheel are in meshing contact with each other according to a reference example.

FIG. 10 is a sectional view of the worm shaft and the worm wheel which are in meshing contact with each other as shown in FIG. 8, as viewed along the axis of rotation of the worm shaft.

FIG. 11 is a sectional view of the worm shaft and the worm wheel which are in meshing contact with each other as shown in FIG. 9, as viewed along the axis of rotation of the worm shaft.

FIG. 12 is a graphic diagram showing a relationship between shaft angle error and loss in transmitted torque in the worm gear of FIG. 10.

FIG. 13 is a graphic diagram showing a relationship between shaft angle error and loss in transmitted torque in the worm gear provided with the tooth profile of FIG. 6.

FIG. 14 is a diagram showing a condition that a tooth of a worm shaft and a tooth space of a worm wheel are in meshing contact with each other in a speed reducer according to a second embodiment of the present invention.

### DETAILED DESCRIPTION OF THE INVENTION

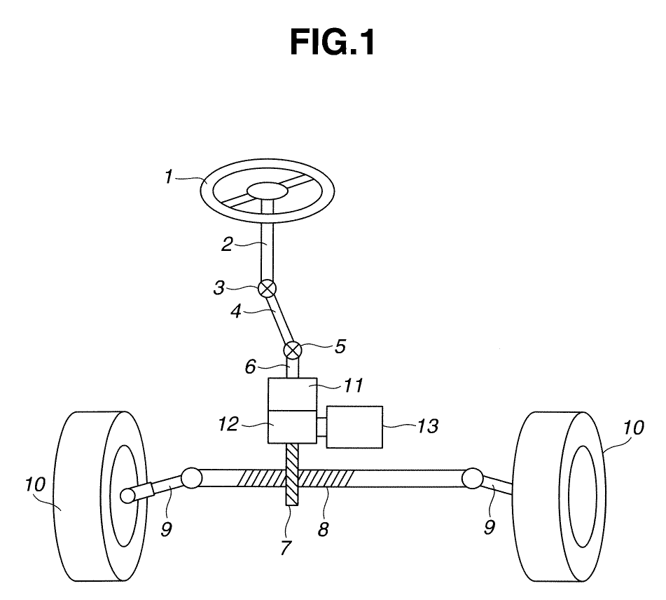

FIG. 1 schematically shows construction of an electric power steering apparatus of an automotive vehicle according to first and second embodiments of the present invention.

As shown in FIG. 1, a steering wheel 1 is connected to an upper shaft 2. Upper shaft 2 is connected to a lower shaft 4 via a universal joint 3. Lower shaft 4 is connected to an input shaft 6 via a universal joint 5. Input shaft 6 is connected to a pinion shaft 7. Upper shaft 2, universal joint 3, lower shaft 4, universal joint 5, input shaft 6, and pinion shaft 7 constitute a steering shaft connected between steering wheel 1 and a steered wheel set 10. Pinion shaft 7 meshes with a rack 8. Rack 8 is linked to tie rods 9, 9. Turning movement of steering wheel 1 causes, via pinion shaft 7 and rack 8, tie rods 9, 9 to steer the steered wheel set 10.

Input shaft 6 is provided with a torque sensor 11 surrounding the input shaft 6. Torque sensor 11 measures a steering torque applied by a driver to input shaft 6. Input shaft 6 is also provided with a speed reducer 12 and an electric motor 13 which surround the input shaft 6. Electric motor 13 applies an assist steering torque to input shaft 6 via speed reducer 12.

Torque sensor 11 outputs a sensing signal to a control unit not shown to which a signal of vehicle speed is also outputted. The control unit allows electric motor 13 to receive electric power form a battery mounted on the vehicle. When steering wheel 1 is turned by a driver, the rotational direction of drive of electric motor 13 is switched according to the turning direction of steering wheel 1, and the output of speed reducer 12 is used to assist the driver's steering torque.

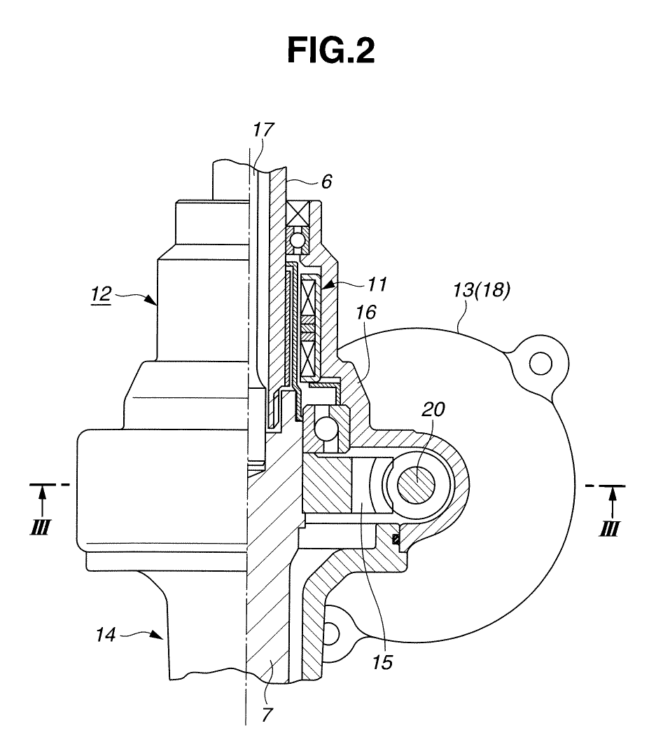

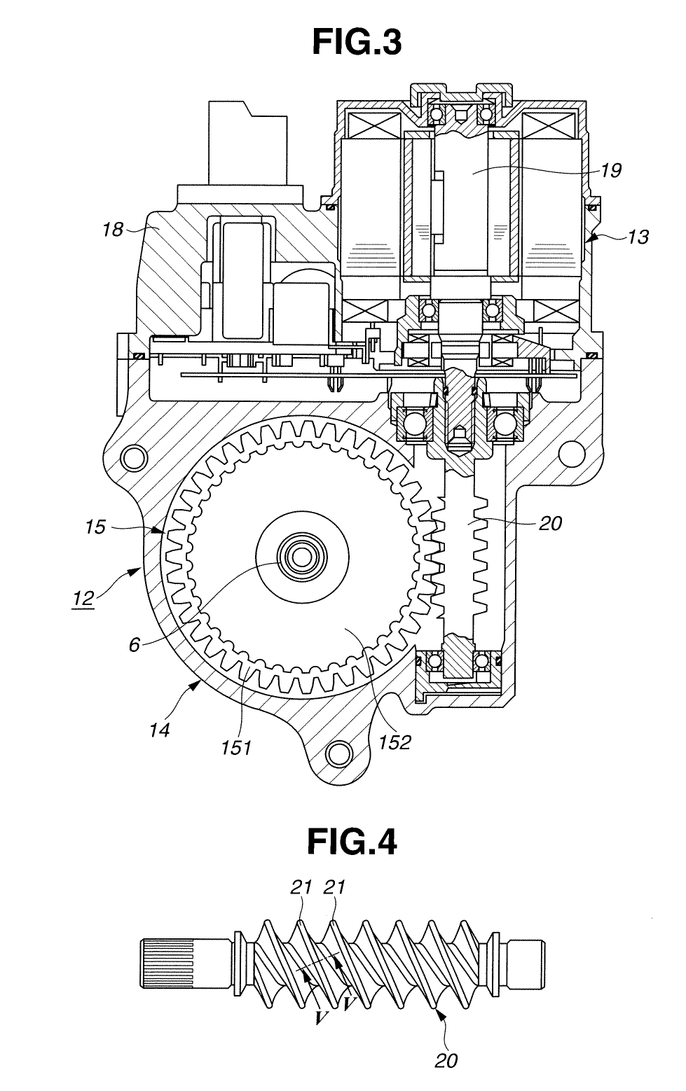

FIG. 2 is a side sectional view of speed reducer 12, and FIG. 3 is a sectional view of speed reducer 12 taken along the line III-III shown in FIG. 2. As shown in FIG. 2, a first housing 14 accommodates pinion shaft 7 and a worm wheel 15. Pinion shaft 7 is rotatably supported on a bearing with respect to first housing 14. First housing 14 is covered by and coupled to a second housing 16. Second housing 16 accommodates torque sensor 11 and a part of input shaft 6. Input shaft 6 is arranged coaxially with pinion shaft 7, and rotatably supported on a bearing with respect to second housing 16. Pinion shaft 7 and input shaft 6 are connected to each other via a torsion bar 17. However, pinion shaft 7 is allowed to rotate with respect to a longitudinal end of input shaft 6 which confronts pinion shaft 7. Worm wheel 15 is fixed to pinion shaft 7.

As shown in FIGS. 2 and 3, a motor housing 18 is attached to a side surface of first housing 14. Motor housing 18 accommodates electric motor 13 which is a reversible brushless motor in this example. Electric motor 13 includes an output shaft 19 which is connected to and arranged coaxially with a worm shaft 20. Worm shaft 20 is rotatably supported on bearings at both ends with respect to first housing 14. Worm shaft 20 meshes with worm wheel 15 so as to form a worm gear as a skew gear with a shaft angle of 90 degrees.

Torque sensor 11, which is housed in second housing 16, is configured to output a signal of torque according to an amount of torsion of torsion bar 17 which is caused by relative rotation between input shaft 6 and pinion shaft 7 according to steering operation of steering wheel 1.

Worm shaft 20 is made of metal and formed by machining with a hob for example. On the other hand, worm wheel 15 is composed of a base part 152 and a contact part 151 including teeth, as shown in FIG. 3. Contact part 151, which is so called a rim, is made of a polyamicle resin such as PA66. Base part 152, which is composed of a part so called a boss and a part so called an arm, is made of metal and formed like a gear. This may be implemented by forming the base part 152 into a gear, setting the base part 152 in a mold, and forming the contact part 151 by injection molding, so that base part 152 and contact part 151 are formed as a unit, and the periphery of base part 152 is covered by contact part 151. The contact between different materials in the worm gear composed of worm shaft 20 and worm wheel 15 serves to reduce noises caused by contact between teeth during operation.

For example, worm wheel 15 has a tooth root diameter of about 110 mm, a module of about 2.1, and a lead angle of about 17 to 18 degrees.

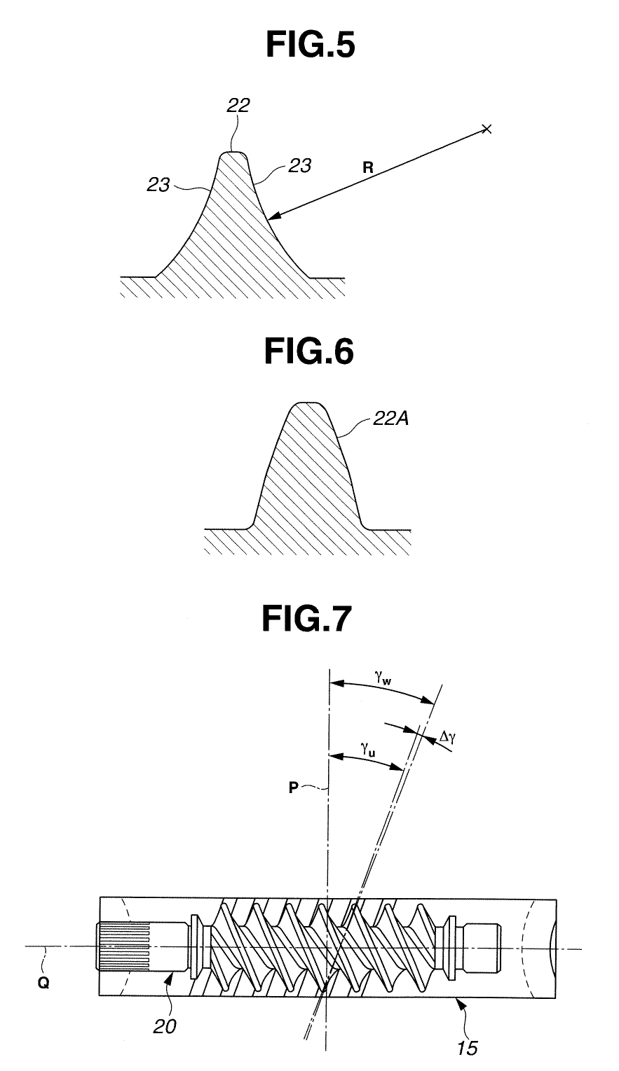

FIG. 4 is a side view of worm shaft 20 as isolated from other parts. FIG. 5 is an enlarged partial sectional view of worm shaft 20 taken along the line V-V shown in FIG. 4, showing a tooth profile of worm shaft 20. Worm shaft 20 includes a plurality of threads, i.e. two threads 21, 21 in this example. In the tooth profile 22 of thread 21, a tooth flank 23 defines an arc-concave edge of a radius of curvature R, as in the case of the Niemann tooth profile. On the other hand, worm wheel 15 includes teeth each of which includes tooth flanks that define arc-convex edges in the tooth profile so as to conform to the tooth profile 22 of worm shaft 20, as shown in FIG. 3.

FIG. 6 is a partial sectional view of a tooth of a worm shaft according to a reference example. This worm shaft has a typical involute tooth profile 22A. The tooth profile 22 shown in FIG. 5 is expected to provide a larger relative radius of curvature between working flanks, for providing a higher load capacity. For this tooth profile, the difference between the thickness of a tooth at the tip and the thickness of the tooth at the root or at the pitch circle tends to be large, because of the arc-concave tooth flanks, as compared to the involute tooth profile 22A.

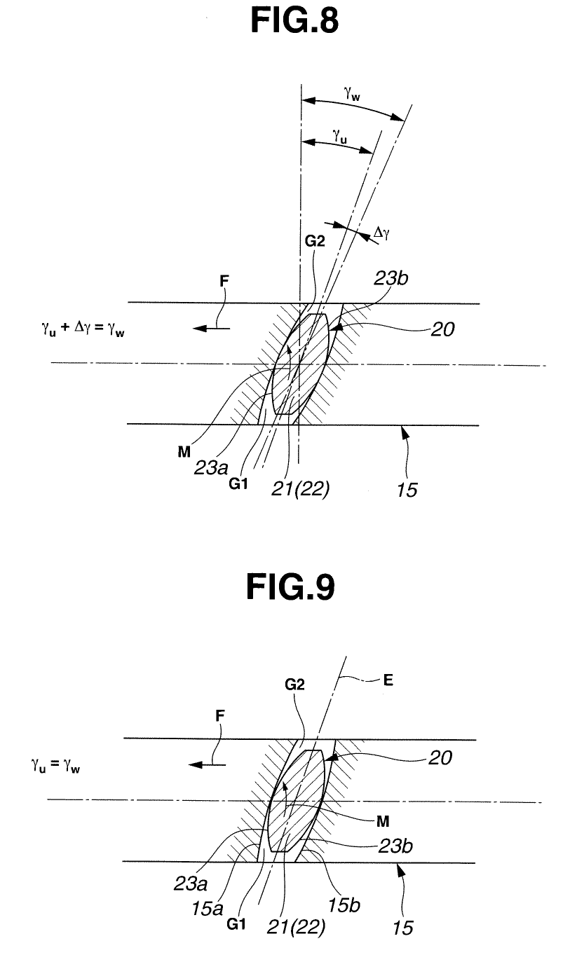

FIG. 7 shows worm shaft 20 and worm wheel 15 which are in meshing contact with each other so as to form a worm gear. FIG. 8 is an enlarged diagram showing a condition that a tooth of worm shaft 20 and a tooth space of worm wheel 15 are in meshing contact with each other. In FIG. 8, M represents a rotational direction of worm shaft 20, and F represents a rotational direction of worm wheel 15.

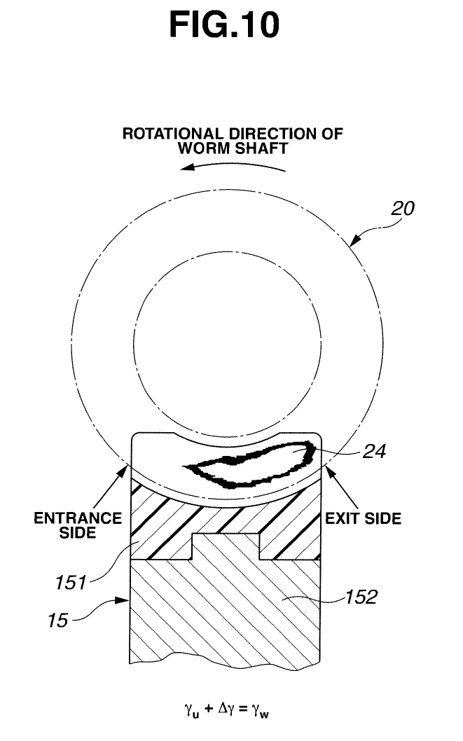

As viewed in FIG. 8, tooth flanks 23a, 23b of worm shaft 20 appear as arc-convex edges, and tooth flanks of worm wheel 15 appear as arc-concave edges, because FIG. 8 shows a sectional view taken along a plane but the thread of worm shaft 20 and the tooth of worm wheel 15 are curved as viewed along the axis of rotation of worm shaft 20 in FIG. 10.

In general, the lead angle of a worm shaft γu and the lead angle of a worm wheel γy are set equal to each other as γu=γw. According to the present embodiment, as shown in FIGS. 7 and 8, lead angle γu of worm shaft 20 and lead angle γw of worm wheel 15 are set different from each other. Specifically, lead angle γw of worm wheel 15 is set larger than lead angle γu of worm shaft 20 as γu<γw (or γu+Δγ−γw, Δγ>0). The difference Δγ is set in the range of 0.2 to 0.7 degree. The clearance between the working flanks of worm wheel 15 and worm shaft 20 corresponds to an amount of crowning.

According to the relationship of γu+Δγ=γw, the worm gear includes worm shaft 20 including thread 21 including tooth flank 23 that defines an arc-concave edge in tooth profile 22, and worm wheel 15 including tooth 151 including a tooth flank that defines an arc-convex edge in the tooth profile, the worm wheel 15 meshing with worm shaft 20 in such a manner that the tooth flank of worm wheel 15 and the tooth flank of worm shaft 20, as working flanks, define therebetween an entrance-side clearance G1 as a clearance where the thread of worm shaft 20 starts to mesh with the tooth of worm wheel 15, and an exit-side clearance G2 as a clearance where the meshing terminates, wherein the exit-side clearance G2 is smaller than the entrance-side clearance G1.

In other words, according to the relationship of γu+Δγ=γw, the worm gear includes worm shaft 20 including thread 21 including tooth flank 23 that defines an arc-concave edge in tooth profile 22, and worm wheel 15 including tooth 151 including a tooth flank that defines an arc-convex edge in the tooth profile, the worm wheel 15 meshing with worm shaft 20 in such a manner that the tooth of worm wheel 15 is inclined with respect to the thread of worm shaft 20 by Δγ in a direction to increase the lead angle of worm shaft 20, so that the exit-side clearance G2 is smaller than the entrance-side clearance G1.

If γu=γw, the entrance-side clearance G1 and exit-side clearance G2 are substantially equal to each other, as shown in FIG. 9.

FIG. 10 is a sectional view of worm shaft 20 and worm wheel 15 which are in meshing contact with each other as shown in FIG. 8, as viewed along the axis of rotation of worm shaft 20. As shown in FIG. 10, a contact area 24 between worm wheel 15 and worm shaft 20 broadly extends from the center to the exit side end in the horizontal direction of FIG. 20. This results in that the contact pressure on the exit side is significantly higher than that on the entrance side. This condition is maintained even when worm wheel 15 rotates in the reverse direction.

The large contact area 24 leads to a decrease in the contact pressure applied to the working tooth flank of worm wheel 15, and thereby leads to a decrease of the bending stress of worm wheel 15. Thus, the durability of the teeth of worm wheel 15 is improved. The fact that the exit-side clearance G2 is smaller than the entrance-side clearance G1 also results in improvement of lubrication of lubricating oil such as grease.

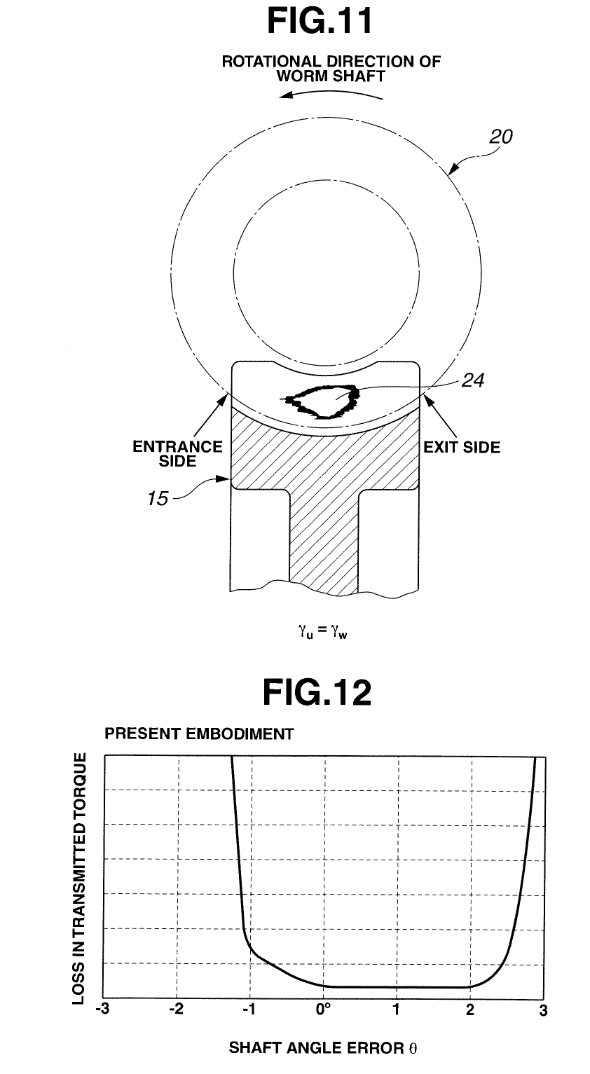

If γu=γw, contact area 24 is smaller and concentrated at the center in the horizontal direction in FIG. 11, as compared to the case of FIG. 10.

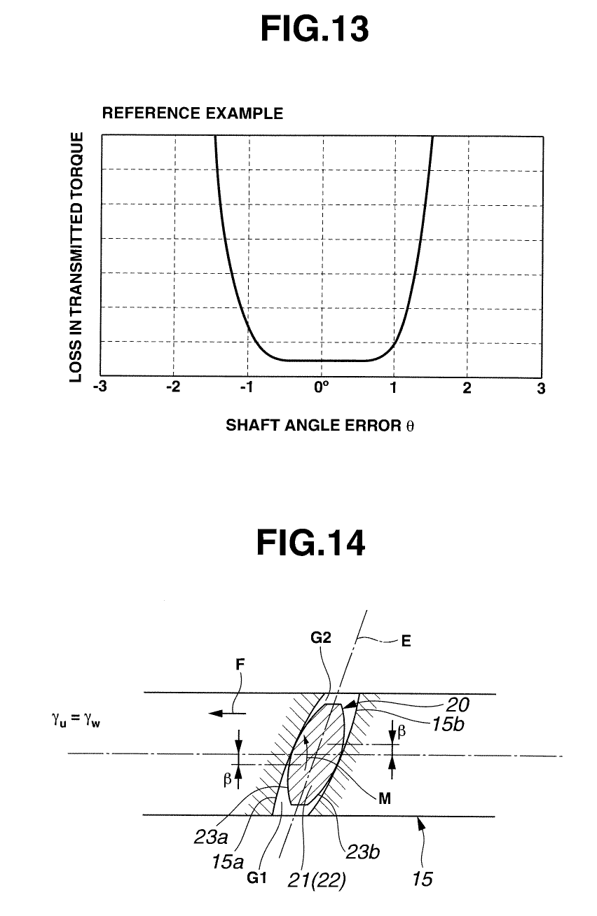

FIG. 12 shows a relationship between shaft angle error and loss in transmitted torque in the worm gear of FIG. 7. FIG. 13 shows a relationship between shaft angle error and loss in transmitted torque in the worm gear provided with the involute tooth profile 22A of FIG. 6. The shaft angle error θ is an angle between the axis of rotation Q of worm shaft 20 and the axis of rotation P of worm wheel 15 with respect to a design value of 90 degrees.

It is to be understood from comparison between FIGS. 12 and 13 that the loss in transmitted torque is small in a wider range of shaft angle error θ in the case of the present embodiment, as compared to the case of the involute tooth profile 22A. This means that a larger shaft angle error θ is allowable in the present embodiment.

According to the present embodiment, the shape of contact part 151 can be easily formed, because contact part 151 is made of resin by injection molding.

The improvement in bending stress of worm wheel 15 makes it unnecessary to strengthen the teeth by increasing the tooth thickness, and/or making the teeth of a glass fiber reinforced plastic, which is conventional measures.

FIG. 14 shows a condition that a tooth of a worm shaft and a tooth space of a worm wheel are in meshing contact with each other according to a second embodiment of the present invention.

In the second embodiment, under the condition of γu=γw, the exit-side clearance G2 is set smaller than the entrance-side clearance G1, as described in detail below.

In the case of FIG. 9 in which γu=γw, the working flank 23a and the non-working flank 23b of worm shaft 20 are symmetrical with respect to a tooth trace reference line E and a central plane perpendicular to tooth trace reference line E, and the working flank 15a and the non-working flank 15b of worm wheel 15 are symmetrical with respect to tooth trace reference line E and the central plane perpendicular to tooth trace reference line E.

In contrast, according to the second embodiment shown in FIG. 14, the working flank 23a and non-working flank 23b of worm shaft 20 are the same as the form shown in FIG. 9, but the working flank 15a and non-working flank 15b of worm wheel 15 are asymmetrical with respect to tooth trace reference line E and the central plane perpendicular to tooth trace reference line E.

In other words, the working flank 15a and non-working flank 15b of worm wheel 15 are offset by an amount of offset β in opposite directions along the tooth trace reference line E, so that the shape of working flank 15a and non-working flank 15b on the entrance side are different from that on the exit side with respect to the central plane perpendicular to tooth trace reference line E.

In this way, the exit-side clearance G2 is set smaller than the entrance-side clearance G1.

The worm gear according to the second embodiment produces similar advantageous effects as in the first embodiment.

Although the worm gears according to the first and second embodiments are worm gears having a shaft angle of 90 degrees as shown in FIG. 7, worm gears may have a shaft angle other than 90 degrees. For example, the worm gear may be configured so that the worm wheel and the worm shaft have identical lead angles, and the worm shaft and the worm wheel form such a shaft angle that the tooth of the worm wheel is inclined with respect to the thread of the worm shaft in the direction to increase the lead angle of the worm shaft. The tooth of the worm wheel may be inclined with respect to the thread of the worm shaft by an angle of 0.2 to 0.7 degree.

This application is based on a prior Japanese Patent Application No. 2007-292779 filed on Nov. 12, 2007. The entire contents of this Japanese Patent Application No. 2007-292779 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A worm gear comprising:
a worm shaft including a thread including a tooth flank that defines a concave edge in a tooth profile of the thread; and
a worm wheel including a tooth including a tooth flank that defines a convex edge in a tooth profile of the tooth, the worm wheel meshing with the worm shaft in such a manner that the tooth flank of the worm wheel and the tooth flank of the worm shaft, as working flanks, define therebetween an entrance-side clearance as a clearance where the thread of the worm shaft starts to mesh with the tooth of the worm wheel, and an exit-side clearance as a clearance where the meshing terminates, wherein the exit-side clearance is smaller than the entrance-side clearance.

2. The worm gear as claimed in claim 1, wherein the worm wheel meshes with the worm shaft in such a manner that the tooth of the worm wheel is inclined with respect to the thread of the worm shaft in a direction to increase a lead angle of the worm shaft.

3. The worm gear as claimed in claim 2, wherein the worm wheel has a larger lead angle than the worm shaft by an angle of 0.2 to 0.7 degree.

4. The worm gear as claimed in claim 1, wherein along a tooth trace of the worm wheel, the tooth flank of the worm wheel includes opposite halves having different shapes so that the exit-side clearance is smaller than the entrance-side clearance.

5. The worm gear as claimed in claim 4, wherein the worm wheel is formed by molding.

6. The worm gear as claimed in claim 1, wherein the tooth flank of the worm wheel as a working flank and an opposite tooth flank of the worm wheel as a non-working flank have different shapes so that the exit-side clearance is smaller than the entrance-side clearance.

7. The worm gear as claimed in claim 1, wherein the worm wheel includes a part made of resin which forms at least the tooth flank of the worm wheel.

8. A worm gear comprising:
a worm shaft including a thread including a tooth flank that defines a concave edge in a tooth profile of the thread; and
a worm wheel including a tooth including a tooth flank that defines a convex edge in a tooth profile of the tooth, the worm wheel meshing with the worm shaft in such a manner that the tooth flank of the worm wheel and the tooth flank of the worm shaft, as working flanks, are subject to a first contact pressure therebetween on an entrance side where the thread of the worm shaft starts to mesh with the tooth of the worm wheel, and a second contact pressure therebetween on an exit side where the meshing terminates, wherein the second contact pressure is higher than the first contact pressure.

9. The worm gear as claimed in claim 8, wherein the worm wheel meshes with the worm shaft in such a manner that the tooth of the worm wheel is inclined with respect to the thread of the worm shaft in a direction to increase a lead angle of the worm shaft.

10. The worm gear as claimed in claim 9, wherein the worm wheel has a larger lead angle than the worm shaft by an angle of 0.2 to 0.7 degree.

11. The worm gear as claimed in claim 8, wherein along a tooth trace of the worm wheel, the tooth flank of the worm wheel includes opposite halves having different shapes so that the second contact pressure is higher than the first contact pressure.

12. The worm gear as claimed in claim 8, wherein the tooth flank of the worm wheel as a working flank and an opposite tooth flank of the worm wheel as a non-working flank have different shapes so that the second contact pressure is higher than the first contact pressure.

13. The worm gear as claimed in claim 8, wherein the worm wheel includes a part made of resin which forms at least the tooth flank of the worm wheel.

14. A worm gear comprising:
a worm shaft including a thread including a tooth flank that defines a concave edge in a tooth profile of the thread; and
a worm wheel including a tooth including a tooth flank that defines a convex edge in a tooth profile of the tooth, the worm wheel meshing with the worm shaft in such a manner that the tooth of the worm wheel is inclined with respect to the thread of the worm shaft in a direction to increase a lead angle of the worm shaft.

15. The worm gear as claimed in claim 14, wherein:
the worm shaft and the worm wheel form a shaft angle of 90 degrees; and
the worm wheel has a larger lead angle than the worm shaft.

16. The worm gear as claimed in claim 14, wherein:
the worm wheel and the worm shaft have identical lead angles; and
the worm shaft and the worm wheel form such a shaft angle that the tooth of the worm wheel is inclined with respect to the thread of the worm shaft in the direction to increase the lead angle of the worm shaft.

17. The worm gear as claimed in claim 16, wherein the tooth of the worm wheel is inclined with respect to the thread of the worm shaft by an angle of 0.2 to 0.7 degree.

18. An electric power steering apparatus comprising:
a steering shaft connected between a steering wheel and a steered wheel set;
an electric motor for applying a torque to the steering shaft;
a worm shaft coupled to an output shaft of the electric motor, the worm shaft including a thread including a tooth flank that defines a concave edge in a tooth profile of the thread; and
a worm wheel coupled to the steering shaft, the worm wheel including a tooth including a tooth flank that defines a convex edge in a tooth profile of the tooth, the worm wheel meshing with the worm shaft in such a manner that the tooth of the worm wheel is inclined with respect to the thread of the worm shaft in a direction to increase a lead angle of the worm shaft.

19. The worm gear as claimed in claim 18, wherein the worm wheel includes a part made of resin which forms at least the tooth flank of the worm wheel.

20. The worm gear as claimed in claim 19, wherein the tooth of the worm wheel is inclined with respect to the thread of the worm shaft by an angle of 0.2 to 0.7 degree.
